(19) United States
(12) Patent Application Publication
(10) Pub. No.: US 2026/0156048 A1
(43) Pub. Date: Jun. 4, 2026

(54) SYSTEM AND METHOD FOR FEDERATED AI-DRIVEN CONTROL AND OPTIMIZATION IN HYBRID CLOUD ENVIRONMENTS

(71) Applicants: Manish KUMAR, Cypress, TX (US); Narendra Balaji MEDIKONDA, Cypress, TX (US)

(72) Inventors: Manish KUMAR, Cypress, TX (US); Narendra Balaji MEDIKONDA, Cypress, TX (US)

(21) Appl. No.: 19/457,302

(22) Filed: Jan. 23, 2026

(51) Int. Cl. H04L 41/16; H04L 9/40; H04L 67/10

(52) U.S. Cl. CPC H04L 41/16; H04L 63/0428; H04L 63/0869; H04L 63/123; H04L 67/10

(57) ABSTRACT

The present disclosure provides a system for federated artificial intelligence driven control and optimization in hybrid cloud environments comprising private cloud infrastructures and public cloud infrastructures. The system enables multiple distributed computing nodes to locally train artificial intelligence models using operational data retained within each node, thereby preventing transfer of raw data across cloud boundaries. Locally trained model parameters are securely transmitted to a coordination processor that authenticates and aggregates the parameters to generate a federated global model representation. The aggregated model representation is deployed back to participating computing nodes and is utilized to generate control outputs for adaptive workload scheduling, resource allocation, scaling, and migration across the hybrid cloud environments. Policy enforcement mechanisms ensure adherence to data locality rules, security constraints, and cloud-specific resource utilization policies during training, aggregation, and deployment.

### TECHNICAL FIELD OF THE INVENTION

The present disclosure relates generally to the field of distributed computing and cloud infrastructure management, and more particularly to a system, method, and device for federated artificial intelligence driven control and optimization across hybrid cloud environments comprising a combination of private cloud resources, public cloud resources, and on-premises computational infrastructure.

### BACKGROUND OF THE INVENTION

Modern enterprise computing environments increasingly rely on hybrid cloud architectures to achieve scalability, fault tolerance, regulatory compliance, and cost efficiency. Such environments typically integrate multiple private data centers, edge computing nodes, and public cloud service providers operating under heterogeneous hardware configurations, virtualization technologies, and network conditions. Existing cloud orchestration and resource management systems primarily rely on centralized control planes that collect telemetry data from distributed nodes and apply static or semi-static optimization policies. These approaches suffer from latency overheads, limited adaptability to local execution contexts, excessive data transfer requirements, and vulnerability to single points of failure.

Furthermore, conventional machine learning driven optimization techniques often require aggregation of raw operational data at a central location for training and inference, which introduces data privacy concerns, regulatory non-compliance, and increased network congestion. In hybrid cloud environments spanning multiple administrative domains, such centralized learning approaches are often infeasible due to data sovereignty restrictions and security constraints. Existing solutions also fail to dynamically adapt optimization strategies based on continuously evolving workload characteristics, infrastructure states, and network conditions across different cloud tiers.

There is therefore a need for a technical solution that enables intelligent, adaptive, and privacy-preserving optimization of hybrid cloud environments by distributing artificial intelligence capabilities across cloud nodes while maintaining coordinated global control. The present disclosure addresses these shortcomings by introducing a federated artificial intelligence driven control and optimization system capable of autonomous learning, decision making, and actuation across hybrid cloud infrastructures.

The rapid evolution of enterprise information technology infrastructure has led to widespread adoption of hybrid cloud environments that integrate private cloud deployments, public cloud services, and on-premises computing resources. Organizations increasingly rely on such hybrid architectures to balance scalability, cost efficiency, regulatory compliance, and operational resilience. Hybrid cloud environments enable dynamic workload distribution across geographically dispersed data centers and cloud service providers, allowing enterprises to respond to fluctuating demand and diverse application requirements. However, the inherent heterogeneity of hybrid cloud infrastructures introduces significant complexity in terms of resource management, performance optimization, security enforcement, and operational coordination.

Traditional cloud management solutions were originally designed for relatively homogeneous environments, such as single-provider public clouds or internally managed private data centers. These solutions typically employ centralized orchestration mechanisms that rely on static policies or rule-based automation to allocate compute, storage, and network resources. While effective in controlled environments, centralized orchestration becomes increasingly inefficient as the scale and diversity of hybrid cloud deployments grow. Central controllers must continuously collect detailed telemetry data from distributed nodes, resulting in high communication overhead, delayed decision making, and limited responsiveness to localized performance fluctuations.

To address these limitations, several vendors have introduced monitoring and analytics platforms that collect infrastructure metrics and apply heuristic or threshold-based optimization strategies. Such platforms often focus on reactive measures, such as scaling resources when predefined utilization thresholds are exceeded or triggering alerts when service degradation is detected. Although these approaches provide basic operational visibility, they lack predictive intelligence and are unable to anticipate complex interactions between workloads, infrastructure components, and network conditions. Consequently, resource allocation decisions may lag behind real-time demand patterns, leading to performance bottlenecks, over-provisioning, or underutilization of expensive cloud resources.

More recent advancements have incorporated machine learning techniques into cloud management systems to enhance predictive capability and automation. These systems typically train models using historical workload data to forecast resource demand or detect anomalies. However, most machine learning driven cloud optimization solutions rely on centralized data aggregation, wherein raw telemetry data from multiple cloud environments is transmitted to a central analytics engine for model training and inference. This centralized learning paradigm introduces several critical drawbacks in hybrid cloud contexts. The transfer of large volumes of operational data across network boundaries increases bandwidth consumption and latency, while also exposing sensitive infrastructure and workload information to potential security risks.

Data privacy and regulatory compliance further complicate centralized learning approaches. Hybrid cloud environments often span multiple jurisdictions, each governed by distinct data protection regulations and compliance requirements. Centralized aggregation of telemetry data may violate data residency rules or organizational security policies, particularly in sectors such as healthcare, finance, and government services. As a result, organizations may be unable or unwilling to share raw operational data across cloud boundaries, limiting the effectiveness of centralized machine learning models and reducing their adaptability to local execution contexts.

Another limitation of existing machine learning based cloud optimization solutions lies in their lack of contextual awareness. Centralized models are typically trained on aggregated data that obscures node-specific characteristics such as hardware configuration, local network topology, energy constraints, and workload affinity. This abstraction reduces the model's ability to make fine-grained optimization decisions tailored to individual nodes or environments. Consequently, optimization policies derived from such models may be suboptimal or even counterproductive when applied uniformly across heterogeneous cloud infrastructures.

Edge computing and on-premises deployments introduce additional challenges for centralized control mechanisms. Latency-sensitive applications, such as real-time analytics, industrial automation, and interactive services, require rapid decision making that cannot tolerate delays associated with centralized orchestration. Existing solutions that depend on periodic communication with a central controller are often unable to meet the stringent latency requirements of such applications. Moreover, intermittent connectivity between edge nodes and central cloud services can disrupt centralized optimization workflows, leading to degraded performance or service interruptions.

Federated learning has emerged as a promising approach to address data privacy and scalability concerns by enabling distributed model training without sharing raw data. In federated learning, individual nodes train local models using their own data and share only model updates with a coordinating entity. While this paradigm has been explored extensively in domains such as mobile devices and healthcare analytics, its application to hybrid cloud control and optimization remains limited. Existing federated learning frameworks are primarily designed for data analytics and prediction tasks rather than real-time infrastructure control. They often lack mechanisms for integrating learned models with operational decision execution and policy enforcement within cloud management systems.

Additionally, current federated learning implementations frequently assume relatively homogeneous client devices and stable participation patterns. Hybrid cloud environments, by contrast, exhibit highly dynamic node availability, varying computational capabilities, and fluctuating workload intensities. Existing federated learning solutions struggle to accommodate such variability, leading to issues such as model divergence, inefficient aggregation, and uneven contribution of nodes. Furthermore, many federated learning systems do not incorporate mechanisms to weight model updates based on infrastructure relevance, reliability, or performance impact, reducing their effectiveness in complex cloud environments.

Another significant drawback of existing solutions is the limited integration between optimization intelligence and enforcement of global policies and service-level objectives. Many cloud optimization tools operate independently of governance and compliance frameworks, resulting in potential conflicts between performance optimization and policy adherence. For example, aggressive workload migration strategies may violate data locality constraints or exceed budgetary limits. The absence of integrated policy validation mechanisms undermines trust in automated optimization systems and necessitates manual oversight, thereby reducing the benefits of automation.

Energy efficiency and sustainability have become critical considerations in modern cloud operations, yet existing solutions often treat energy management as a secondary concern. Traditional resource schedulers focus primarily on performance metrics such as latency and throughput, with limited awareness of energy consumption patterns across distributed infrastructure. Machine learning based solutions that do consider energy metrics typically rely on coarse-grained models that fail to capture the complex trade-offs between performance, cost, and power consumption in hybrid cloud environments. This limitation hampers efforts to optimize resource usage in alignment with organizational sustainability goals.

Security considerations also present challenges for existing cloud optimization approaches. Centralized control planes represent attractive targets for cyber attacks, as compromising the central controller can grant attackers extensive control over cloud infrastructure. Although security mechanisms such as encryption and authentication are commonly employed, the concentration of control logic and sensitive data in a single entity increases systemic risk. Distributed environments require optimization solutions that minimize centralized exposure while maintaining coordinated control.

In summary, existing solutions for hybrid cloud management and optimization suffer from a combination of architectural, operational, and regulatory limitations. Centralized orchestration and analytics approaches struggle with scalability, latency, data privacy, and fault tolerance. Machine learning driven solutions often depend on centralized data aggregation, lack contextual awareness, and fail to integrate seamlessly with real-time control and policy enforcement. Federated learning frameworks, while promising, are not sufficiently adapted to the dynamic and heterogeneous nature of hybrid cloud infrastructures. These shortcomings highlight the need for a federated AI-driven control and optimization approach specifically designed for hybrid cloud environments, capable of distributing intelligence, preserving data privacy, adapting to local conditions, and maintaining global coordination without the drawbacks of existing solutions.

### SUMMARY OF THE INVENTION

The present disclosure provides a system and method for federated AI-driven control and optimization in hybrid cloud environments, wherein artificial intelligence models are trained and executed in a distributed manner across multiple cloud nodes without requiring centralized aggregation of raw data. The system enables continuous monitoring of infrastructure parameters, workload behavior, and network performance, followed by local learning and inference at individual nodes and federated aggregation of model parameters to achieve coordinated global optimization.

The invention further provides a physical device in the form of a dedicated control apparatus configured to interface with hybrid cloud resources, execute federated learning workflows, and perform real-time optimization actions on computing, storage, and network resources. The disclosed system improves scalability, reduces latency, enhances fault tolerance, preserves data privacy, and enables adaptive control across heterogeneous cloud environments.

The principal object of the present invention is to provide a system and method for federated AI-driven control and optimization in hybrid cloud environments that enables intelligent, adaptive, and coordinated management of computing, storage, and network resources across private clouds, public clouds, and on-premises infrastructure without reliance on centralized data aggregation.

Another object of the invention is to enable distributed artificial intelligence learning and inference at individual cloud nodes while preserving data privacy and data sovereignty by ensuring that raw operational and workload data remains local to each node and only abstracted or learned model parameters are exchanged for global coordination.

A further object of the invention is to reduce latency and improve responsiveness of cloud control decisions by allowing local optimization actions to be executed in near real time at distributed nodes based on locally learned models, thereby minimizing dependence on remote centralized controllers and long-distance communication paths.

Another object of the invention is to provide continuous, autonomous optimization of hybrid cloud environments by dynamically adapting to changing workload patterns, infrastructure states, network conditions, and energy consumption characteristics through iterative federated learning cycles.

An additional object of the invention is to improve scalability and fault tolerance of cloud management systems by distributing intelligence and control functions across multiple nodes, thereby eliminating single points of failure and enabling resilient operation even under partial network disruptions or node unavailability.

Another object of the invention is to enable fine-grained, context-aware optimization by incorporating node-specific characteristics, including hardware capabilities, local network topology, energy constraints, and workload affinity, into the learning and decision-making process.

A further object of the invention is to integrate performance optimization with policy enforcement by validating locally inferred control actions against global compliance, security, cost, and service-level constraints, thereby ensuring that automated optimization does not violate organizational or regulatory requirements.

Another object of the invention is to optimize resource utilization and operational cost across hybrid cloud infrastructures by intelligently coordinating workload placement, scaling decisions, and resource provisioning based on predictive and adaptive artificial intelligence models.

An additional object of the invention is to improve energy efficiency and sustainability of hybrid cloud operations by incorporating energy consumption metrics and power management considerations into the federated learning and optimization framework.

Another object of the invention is to enhance security of cloud control mechanisms by minimizing centralized exposure of sensitive data and control logic, and by employing secure communication and cryptographic techniques for model parameter exchange and coordination.

A further object of the invention is to provide a dedicated physical device and machine structure capable of executing federated learning coordination, policy validation, and optimization control functions, thereby enabling seamless integration with existing data center and cloud management infrastructure.

Another object of the invention is to support heterogeneous cloud environments and multi-vendor deployments by providing an adaptable and extensible control architecture capable of interfacing with diverse virtualization, containerization, and orchestration technologies.

An additional object of the invention is to enable proactive and predictive cloud management by anticipating performance degradation, resource contention, and fault conditions before they impact service quality, and by autonomously initiating corrective actions across the hybrid cloud environment.

A further object of the invention is to reduce manual intervention and operational complexity in managing large-scale hybrid cloud systems by providing an intelligent, self-learning, and self-optimizing control mechanism that continuously improves its decision-making accuracy over time.

These and other objects of the invention collectively contribute to a technically advanced, robust, and scalable solution for federated AI-driven control and optimization in hybrid cloud environments, overcoming the limitations of existing centralized and semi-automated cloud management approaches.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for federated artificial intelligence driven control and optimization in hybrid cloud environments; and

FIG. 2 displays flow chart of a method for federated artificial intelligence driven control and optimization in hybrid cloud environments.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

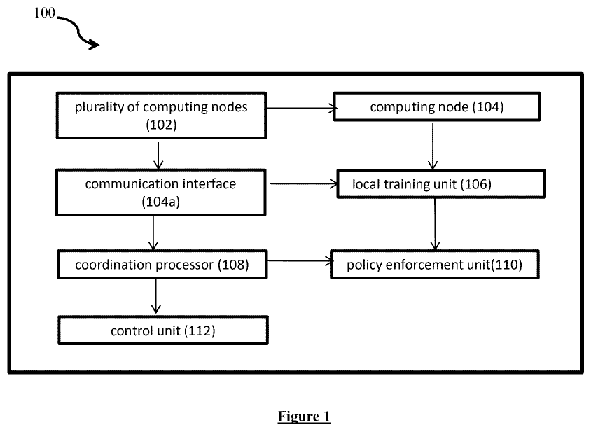

Referring to FIG. 1, a block diagram of a system for federated artificial intelligence driven control and optimization in hybrid cloud environments is illustrated. The system 100 comprises: a plurality of computing nodes (102) distributed across at least one private cloud environment and at least one public cloud environment; each computing node (104) comprising a processor, a non-transitory memory, and a communication interface (104a); a local training unit (106) stored in the non-transitory memory and executed by the processor of each computing node, the local training unit being configured to train a local artificial intelligence model using locally stored data without transferring the locally stored data outside the respective computing node; a coordination processor (108) communicatively coupled to the plurality of computing nodes through the communication interface, the coordination processor being configured to receive locally trained model parameters from each computing node and to generate a global model representation based on an aggregation of the received model parameters; a policy enforcement unit (110) operatively coupled to the coordination processor, the policy enforcement unit being configured to apply deployment constraints based on cloud resource type, data locality requirements, and security policies; and a control unit (112) configured to deploy the global model representation back to the plurality of computing nodes for controlling and optimizing resource utilization, workload execution, and service performance across the hybrid cloud environments.

In an embodiment, each computing node (104) further comprises a data isolation unit configured to restrict access to locally stored data at a hardware abstraction level, and wherein the local training unit is configured to access the locally stored data only through the data isolation unit to prevent direct data exposure during federated training.

In an embodiment, the coordination processor (108) further comprises a model version management unit configured to assign version identifiers to each received local model parameter set, to maintain a chronological record of aggregation cycles, and to roll back deployment of the global model representation upon detection of performance degradation in the hybrid cloud environments. In an embodiment, the communication interface (104a) of each computing node is configured to perform encrypted parameter exchange using mutually authenticated secure channels, and wherein the coordination processor is configured to validate integrity of received model parameters prior to aggregation. In an embodiment, the policy enforcement unit (110) is further configured to dynamically adjust participation of individual computing nodes in federated training based on real-time measurements of network latency, compute load, and energy consumption associated with each computing node.

In an embodiment, the control unit (112) further comprises a resource orchestration unit configured to allocate processing capacity, memory allocation, and storage input output priority across the hybrid cloud environments based on inference outputs generated by the deployed global model representation.

In an embodiment, the coordination processor further comprises an anomaly assessment unit configured to compare successive global model representations and to identify statistically significant deviations in parameter distributions indicative of faulty or compromised computing nodes, and wherein such nodes are selectively excluded from subsequent aggregation cycles.

In an embodiment, each computing node further comprises a local evaluation unit configured to compute performance metrics associated with the deployed global model representation using locally observed workload behavior, and wherein the computed performance metrics are transmitted to the coordination processor for adaptive optimization.

In an embodiment, the coordination processor (108) is further configured to perform hierarchical aggregation by grouping computing nodes based on cloud environment type and aggregating model parameters at an intermediate level prior to generation of the global model representation.

In an embodiment, the control unit (112) is further configured to initiate automated scaling, migration, or throttling of workloads across the private cloud environment and the public cloud environment based on predictive outputs generated by the global model representation, thereby maintaining predefined service level objectives under variable demand conditions.

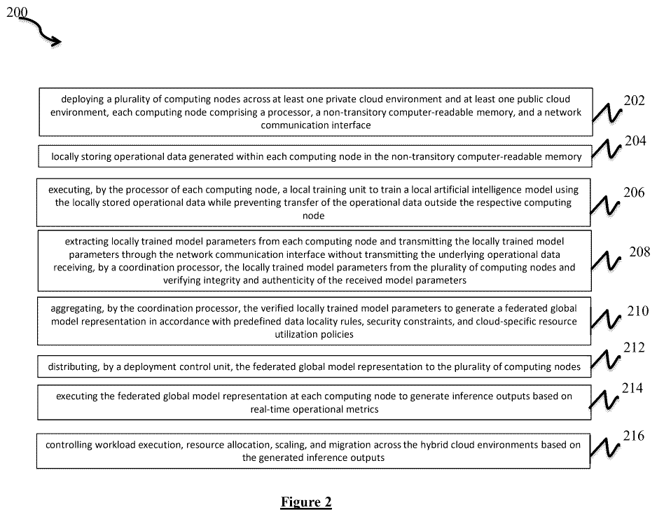

Referring to FIG. 2, a flow chart for a method for federated artificial intelligence driven control and optimization in hybrid cloud environments, the method comprising the steps of is illustrated. The method 200 comprises:
At step 202, the method 200 includes deploying a plurality of computing nodes across at least one private cloud environment and at least one public cloud environment, each computing node comprising a processor, a non-transitory computer-readable memory, and a network communication interface;
At step 204, the method 200 includes locally storing operational data generated within each computing node in the non-transitory computer-readable memory;
At step 206, the method 200 includes executing, by the processor of each computing node, a local training unit to train a local artificial intelligence model using the locally stored operational data while preventing transfer of the operational data outside the respective computing node;
At step 208, the method 200 includes extracting locally trained model parameters from each computing node and transmitting the locally trained model parameters through the network communication interface without transmitting the underlying operational data; receiving, by a coordination processor, the locally trained model parameters from the plurality of computing nodes and verifying integrity and authenticity of the received model parameters;
At step 210, the method 200 includes aggregating, by the coordination processor, the verified locally trained model parameters to generate a federated global model representation in accordance with predefined data locality rules, security constraints, and cloud-specific resource utilization policies;
At step 212, the method 200 includes distributing, by a deployment control unit, the federated global model representation to the plurality of computing nodes;
At step 214, the method 200 includes executing the federated global model representation at each computing node to generate inference outputs based on real-time operational metrics; and
At step 216, the method 200 includes controlling workload execution, resource allocation, scaling, and migration across the hybrid cloud environments based on the generated inference outputs.

In an embodiment, the method executing the local training unit further comprises initializing the local artificial intelligence model using a previously deployed federated global model representation, iteratively updating model parameters based on locally observed workload performance metrics, and terminating local training upon satisfying a predefined local convergence condition stored in the non-transitory computer-readable memory.

In an embodiment, the method transmitting the locally trained model parameters further comprises serializing the model parameters, applying cryptographic encryption, attaching integrity verification data, and transmitting the encrypted model parameters over a mutually authenticated secure communication channel.

In an embodiment, the method verifying integrity and authenticity of the received model parameters further comprises validating a digital identity associated with each computing node, checking integrity verification data, and rejecting model parameters received from unauthorized or compromised computing nodes.

In an embodiment, the method aggregating the verified locally trained model parameters further comprises applying weighted aggregation based on at least one of workload volume, historical reliability of the computing node, network latency, or available processing capacity of the computing node.

In an embodiment, aggregating the verified locally trained model parameters further comprises performing hierarchical aggregation by first aggregating model parameters within groups of computing nodes associated with a same cloud environment type, and subsequently aggregating intermediate results to generate the federated global model representation.

In an embodiment, the method distributing the federated global model representation further comprises assigning a version identifier to the federated global model representation, storing version metadata, and selectively deploying the federated global model representation only to computing nodes that satisfy predefined policy constraints.

In an embodiment, the method executing the federated global model representation further comprises generating predictive outputs indicative of future resource demand, workload performance, or service congestion, and wherein controlling further comprises proactively adjusting resource allocation prior to occurrence of predicted performance degradation.

In an embodiment, the method controlling workload execution further comprises dynamically scaling processing resources, reallocating memory resources, or migrating workloads between private cloud environments and public cloud environments based on the generated inference outputs.

In an embodiment, the method comprising monitoring performance indicators associated with the deployed federated global model representation at each computing node, transmitting the performance indicators to the coordination processor, and initiating a subsequent federated training cycle in response to detected deviation from predefined performance thresholds.

In an embodiment, executing the federated global model representation further comprises generating predictive outputs indicative of future resource demand, workload performance, or service congestion, and wherein controlling further comprises proactively adjusting resource allocation prior to occurrence of predicted performance degradation, wherein controlling workload execution further comprises dynamically scaling processing resources, reallocating memory resources, or migrating workloads between private cloud environments and public cloud environments based on the generated inference outputs; monitoring performance indicators associated with the deployed federated global model representation at each computing node, transmitting the performance indicators to the coordination processor, and initiating a subsequent federated training cycle in response to detected deviation from predefined performance thresholds.

In this embodiment, the federated global model representation is executed as a continuously operating inference layer across a hybrid cloud infrastructure to forecast short-term and near-future system behavior using real-time and historical operational data streams. The model processes telemetry such as CPU utilization trends, memory access patterns, network queue depths, request arrival rates, service response latency, and workload execution traces to generate time-indexed predictions of resource demand, performance degradation probability, and congestion formation at both node and cluster levels. For example, in a hybrid financial transaction platform where peak transaction volumes occur at predictable time windows, the model learns recurring saturation patterns and predicts that a private cloud cluster will exceed its CPU and memory thresholds within a defined forecast horizon. Based on this predictive output, the control layer initiates proactive resource orchestration actions before the degradation actually occurs, such as reserving additional virtual processors from a public cloud pool, reallocating memory pages across virtual machines, or live-migrating selected workloads from an overloaded private node to an underutilized public cloud node.

During runtime, each computing node continuously monitors performance indicators associated with the deployed global model, including inference confidence levels, prediction error rates, workload response times, queue lengths, and resource utilization efficiency. These indicators are locally buffered and periodically transmitted to the coordination processor, which evaluates them against predefined operational and model-performance thresholds. When the coordination processor detects sustained deviation, such as rising prediction error or recurring control inefficiencies, it automatically initiates a subsequent federated training cycle by issuing a retraining trigger to all participating nodes. This mechanism ensures that the model adapts to evolving workload behaviors, hardware changes, and usage patterns. The technical effect achieved is a closed-loop, self-optimizing hybrid cloud control system that transitions from reactive scaling to predictive, preemptive orchestration, thereby reducing service outages, minimizing resource overprovisioning, and significantly improving workload stability and infrastructure efficiency.

In an embodiment, executing the local training unit at each computing node further comprises: maintaining, in the non-transitory computer-readable memory, a local training state buffer storing a plurality of training state variables including a current training iteration counter, a local loss convergence value, a parameter update delta history, and a timestamp of last successful synchronization; detecting, by the processor, a training trigger event based on a change in at least one operational metric exceeding a stored threshold; loading, into an execution register, the previously deployed federated global model representation and mapping its parameter structure to a locally instantiated parameter index table; computing successive parameter updates using locally stored operational data while storing each update in a delta cache separate from the original parameter structure; and updating the training state buffer after each iteration to determine whether the predefined local convergence condition is satisfied.

In this embodiment, each computing node executes its local training unit as a state-aware and event-driven learning engine that is tightly coupled with the operational behavior of the node. A dedicated training state buffer is persistently maintained in the non-transitory memory and continuously updated to reflect the progress and reliability of the local training process. This buffer stores synchronized state variables such as the current training iteration count, a rolling loss convergence value derived from the most recent training epochs, a historical record of parameter update deltas, and a timestamp identifying the last successful synchronization with the

coordination processor. By preserving this state information across execution cycles and system restarts, the node is able to resume training deterministically and avoid redundant recomputation, thereby improving both stability and computational efficiency.

The training process is not initiated arbitrarily, but is triggered only when a monitored operational metric, such as a sudden increase in request latency, abnormal memory access behavior, or a shift in data distribution, exceeds a predefined threshold stored locally. Once such a trigger is detected, the processor loads the previously deployed federated global model representation into an execution register and maps its parameter structure into a locally instantiated parameter index table. This mapping establishes a direct correspondence between global parameters and local memory addresses, enabling rapid lookup, update, and rollback of individual weights without restructuring the model. Using locally collected operational data, the node then computes successive parameter updates through iterative optimization cycles. Each computed update is written into a dedicated delta cache that is physically and logically separated from the original parameter memory, ensuring that intermediate or unstable updates do not corrupt the deployed model state.

After each iteration, the training state buffer is updated to reflect the new loss convergence value, delta magnitude, and iteration index, and these values are evaluated against a predefined local convergence condition. When the convergence condition is satisfied, such as when the loss gradient stabilizes within an acceptable margin over a defined number of iterations, the local training unit terminates the update cycle and prepares the validated parameter deltas for extraction and transmission. The technical effect achieved by this architecture is a resilient, resource-efficient, and self-regulating local learning mechanism that minimizes unnecessary training, preserves model integrity, and ensures that only stable, high-quality parameter updates contribute to the federated model, thereby significantly improving convergence reliability and overall system performance.

In an embodiment, extracting the locally trained model parameters further comprises: comparing the locally updated parameter values with the parameter values of the previously deployed federated global model representation to compute a parameter delta vector; encoding the parameter delta vector using a node-specific serialization schema stored in the non-transitory computer-readable memory; segmenting the encoded parameter delta vector into transmission blocks having sequence identifiers; and storing a cryptographic hash for each transmission block in a transmission ledger prior to applying cryptographic encryption.

In this embodiment, once local training converges, the computing node performs a differential extraction process that isolates only the meaningful changes produced during training rather than retransmitting the entire model. The processor first aligns the locally updated parameter set with the parameter structure of the previously deployed federated global model representation and computes a parameter delta vector that numerically represents the difference between the two states. This vector therefore captures only the learned adaptations arising from local operational data, such as shifts in workload behavior or resource contention patterns. For example, if only a subset of neural weights associated with memory utilization prediction has changed during training, only those modified values are reflected in the delta vector, significantly reducing the volume of data to be transmitted.

The parameter delta vector is then encoded using a node-specific serialization schema stored in non-transitory memory, which defines the data type, byte order, compression format, and structural layout optimized for the node's processor architecture and communication interface. This ensures that the encoded representation is both compact and compatible with the coordination processor during reconstruction. The encoded data stream is subsequently segmented into a sequence of fixed-size transmission blocks, each assigned a unique sequence identifier that preserves ordering and enables deterministic reassembly. Prior to any encryption, a cryptographic hash is generated for each transmission block and recorded in a secure transmission ledger maintained locally at the node. This ledger creates an immutable integrity reference for every segment, allowing later verification that each block has not been altered or corrupted in transit. The technical effect achieved by this staged extraction and preparation process is a highly efficient, bandwidth-optimized, and tamper-resistant model update pipeline that ensures secure and verifiable propagation of learning contributions within the federated system while minimizing communication overhead and synchronization latency.

In an embodiment, transmitting the encrypted model parameters further comprises: initiating a secure session handshake with the coordination processor using a node-bound cryptographic identity; transmitting the sequence-identified transmission blocks in a predefined order; awaiting receipt acknowledgements from the coordination processor for each transmission block; and retransmitting any block for which a valid acknowledgement is not received within a stored timeout period.

In this embodiment, the transmission phase is implemented as a secure, stateful communication protocol that ensures both authenticity and reliable delivery of the locally trained model updates to the coordination processor. Before any data transfer occurs, the computing node establishes a secure session by initiating a cryptographic handshake using a node-bound identity, such as a hardware-rooted private key or a device certificate stored in a secure enclave. This handshake mutually authenticates the node and the coordination processor and derives a temporary session key that is used to encrypt all subsequent communications, thereby preventing impersonation, replay attacks, and unauthorized interception of model updates.

Once the secure channel is established, the node begins transmitting the encrypted transmission blocks in the predefined sequence defined by their identifiers. Each block is sent individually and the node transitions into a wait state until a corresponding receipt acknowledgement is returned from the coordination processor, confirming successful reception and integrity verification of that block. If an acknowledgement is not received within a locally stored timeout interval, the node automatically retransmits only the missing or unconfirmed block rather than restarting the entire transmission. For example, in a geographically distributed hybrid cloud deployment where transient packet loss may occur, this mechanism guarantees that partial failures do not corrupt the update stream or stall the aggregation cycle. The technical effect achieved by this controlled transmission protocol is a fault-tolerant, secure, and deterministic update delivery process that ensures every parameter delta block is reliably and verifiably received, thereby preserving synchronization accuracy and strengthening the robustness of the federated learning system across unstable network environments.

In an embodiment, receiving and verifying the locally trained model parameters further comprises: temporarily storing each encrypted transmission block in a quarantine buffer; decrypting each transmission block using a coordination processor decryption key; reconstructing the parameter delta vector using the sequence identifiers; comparing a recalculated cryptographic hash with the corresponding stored hash received from the computing node; and moving only verified parameter delta vectors to an aggregation staging memory region.

In this embodiment, the coordination processor enforces a multi-stage verification pipeline that isolates untrusted data and prevents corrupted or malicious updates from entering the federated aggregation workflow. Each encrypted transmission block received from a computing node is first written into a protected quarantine buffer that is logically separated from the aggregation memory space and is not accessible to the model update engine. This isolation ensures that no unverified data can influence the global model state or compromise the execution environment. The processor then decrypts each block using a coordination-processor-held decryption key associated with the secure session established with the sending node, thereby restoring the original encoded parameter data while preserving confidentiality during transit.

Using the embedded sequence identifiers, the decrypted blocks are deterministically reassembled to reconstruct the full parameter delta vector in the correct order. For each reconstructed block, the coordination processor independently recalculates a cryptographic hash and compares it with the corresponding hash value that was transmitted from the computing node and recorded in the transmission ledger. If any mismatch is detected, the entire delta vector is flagged as invalid and discarded, preventing partial or corrupted updates from being aggregated. Only when all blocks pass the integrity verification are the reconstructed parameter delta vectors transferred from the quarantine buffer into a secure aggregation staging memory region. The technical effect achieved by this layered verification mechanism is a tamper-resistant and fault-isolated update ingestion process that ensures only authentic, intact, and correctly ordered model updates are admitted into the federated aggregation pipeline, thereby significantly enhancing the reliability, security, and trustworthiness of the distributed learning system.

In an embodiment, aggregating the verified locally trained model parameters further comprises: maintaining a node performance profile table storing historical convergence time, parameter divergence magnitude, and update reliability score for each computing node; computing a dynamic aggregation weight for each parameter delta vector using values retrieved from the node
performance profile table; scaling each parameter delta vector according to the computed dynamic aggregation weight; and summing the scaled parameter delta vectors to update a global parameter state matrix, and wherein hierarchical aggregation further comprises: assigning each computing node to an environment cluster based on whether the node is deployed in the private cloud environment or the public cloud environment; aggregating scaled parameter delta vectors within each environment cluster to generate environment-level parameter matrices; normalizing the environment-level parameter matrices using stored cluster weight coefficients; and aggregating the normalized environment-level parameter matrices to update the global parameter state matrix.

In this embodiment, the coordination processor performs aggregation as an adaptive, reliability-aware computation rather than a simple arithmetic averaging operation, thereby improving convergence accuracy and resilience in heterogeneous hybrid cloud environments. A persistent node performance profile table is maintained in memory, where each participating computing node is associated with historical metrics such as its average convergence time, the magnitude of parameter divergence from the global model, and an update reliability score derived from past transmission success, validation outcomes, and retraining stability. When a new verified parameter delta vector arrives from a node, the coordination processor retrieves the corresponding profile values and computes a dynamic aggregation weight that reflects the trustworthiness and learning quality of that node. For example, a node that consistently converges quickly with low divergence and high transmission reliability is assigned a higher weight, while a node exhibiting unstable updates or delayed synchronization is automatically down-weighted.

Each parameter delta vector is then mathematically scaled by its computed dynamic aggregation weight before being merged with other updates. The scaled vectors are summed to incrementally update the global parameter state matrix, ensuring that higher-quality learning contributions exert a stronger influence on the evolving global model. In hybrid deployments, the aggregation process is further structured hierarchically by clustering computing nodes based on whether they operate in private or public cloud environments. Within each cluster, the scaled parameter delta vectors are first aggregated to form environment-level parameter matrices that capture localized learning behavior under similar infrastructure conditions. These environment-level matrices are then normalized using stored cluster weight coefficients that reflect the relative stability, performance, or strategic priority of each environment. Finally, the normalized environment-level parameter matrices are aggregated to update the global parameter state matrix. The technical effect achieved by this weighted and hierarchical aggregation architecture is a faster, more stable, and bias-resistant global model convergence process that accounts for environmental heterogeneity, reduces the impact of noisy or unreliable nodes, and significantly improves the robustness and predictive accuracy of the federated learning system.

In an embodiment, distributing the federated global model representation further comprises: embedding the updated global parameter state matrix into a model package container including a version identifier, dependency map, and deployment compatibility descriptor; generating a deployment manifest identifying eligible computing nodes based on stored policy constraints;
transmitting the model package container only to computing nodes listed in the deployment manifest; and storing, at each receiving computing node, the version identifier and deployment compatibility descriptor prior to execution; wherein executing the federated global model representation further comprises: loading the received model package container into a runtime inference engine; binding real-time operational metrics to input parameter channels defined in the dependency map; executing inference cycles at predefined time intervals; and writing inference outputs to a control decision buffer accessible to a workload orchestration module.

In this embodiment, the coordination processor implements a controlled and version-aware distribution mechanism that ensures only compatible and authorized computing nodes receive and execute the updated federated global model representation. After aggregation, the global parameter state matrix is encapsulated into a structured model package container that also includes a unique version identifier, a dependency map defining the required runtime libraries, data interfaces, and input feature bindings, and a deployment compatibility descriptor specifying supported processor types, memory requirements, virtualization layers, and security policies. This packaging process ensures that the model can be deterministically deployed and executed across heterogeneous environments without manual reconfiguration or runtime failures.

Before transmission, the coordination processor generates a deployment manifest by evaluating stored policy constraints, such as hardware capabilities, security clearance, regulatory boundaries, and workload criticality, to identify which computing nodes are eligible to receive the updated model. The model package container is then transmitted only to the nodes listed in the manifest, preventing incompatible or unauthorized systems from loading the model. Upon receipt, each computing node stores the version identifier and deployment compatibility descriptor in local non-transitory memory and verifies that the package matches its execution environment before activation, thereby preventing version conflicts and runtime instability.

During execution, the model package container is loaded into a runtime inference engine that dynamically resolves the dependencies defined in the dependency map and binds live operational metrics, such as CPU load, memory utilization, network throughput, and request latency, to the input parameter channels expected by the model. The inference engine executes prediction cycles at predefined time intervals, for example every few seconds in a latency-sensitive application, and writes the resulting inference outputs into a control decision buffer that is shared with a workload orchestration module. This architecture enables seamless integration between federated intelligence and real-time infrastructure control, achieving the technical effect of automated, low-latency, and policy-compliant deployment of predictive models that continuously drive adaptive resource management across the hybrid cloud system.

In an embodiment, controlling workload execution further comprises: retrieving inference outputs from the control decision buffer; evaluating the inference outputs against stored control rule conditions; generating at least one control action command corresponding to resource allocation, scaling, or migration; and transmitting the control action command to a cloud resource manager interface associated with the hybrid cloud environment; wherein monitoring performance indicators further comprises: collecting inference accuracy metrics, control response latency, and resource utilization metrics; storing the collected metrics in a performance log buffer; transmitting the performance log buffer to the coordination processor at predefined intervals; and comparing the transmitted performance indicators with predefined performance thresholds stored at the coordination processor; wherein initiating the subsequent federated training cycle further comprises: generating a retraining trigger signal when deviation from predefined performance thresholds is detected; broadcasting the retraining trigger signal to the plurality of computing nodes; resetting the local training state buffer at each computing node; and executing a new local training cycle using the previously deployed federated global model representation as an initialization baseline.

In this embodiment, workload control is implemented as an automated, rule-governed feedback system that directly converts model intelligence into real-time infrastructure actions. Each computing node retrieves the most recent inference outputs from the control decision buffer and evaluates them against a set of stored control rule conditions that define acceptable operating ranges and response strategies. These rules may specify, for example, that when predicted CPU utilization exceeds a threshold within a forecast horizon, additional virtual processors must be provisioned, or that when predicted latency for a service class rises beyond an allowable limit, selected workloads must be migrated to a less congested environment. Based on this evaluation, the system generates one or more control action commands that correspond to resource allocation, horizontal or vertical scaling, or cross-environment workload migration. The commands are transmitted through a standardized cloud resource manager interface that directly orchestrates the underlying hybrid cloud infrastructure, enabling automated and low-latency execution without manual intervention.

In parallel, the system continuously monitors operational and model-level performance indicators to validate the effectiveness of the control actions and the accuracy of the federated model. Metrics such as inference prediction accuracy, end-to-end control response latency, CPU and memory utilization efficiency, and workload throughput are collected at each node and written into a performance log buffer. These buffered metrics are transmitted to the coordination processor at predefined intervals, where they are compared against stored performance thresholds representing acceptable system behavior and model reliability. When sustained deviation is detected, such as rising prediction error or delayed control response, the coordination processor generates a retraining trigger signal and broadcasts it to all participating computing nodes. Upon receiving this signal, each node resets its local training state buffer to a known baseline and initiates a new local training cycle using the previously deployed federated global model representation as the initialization point. The technical effect achieved is a closed-loop, self-correcting control architecture that continuously aligns predictive intelligence with real-world system behavior, ensuring long-term performance stability, rapid adaptation to changing workloads, and significantly improved efficiency across the hybrid cloud environment.

In an embodiment, the coordination processor further maintains a global synchronization controller configured to: store, in a synchronization state table, an expected update interval for each computing node; detect, based on the synchronization state table, a delayed or missing parameter update from a computing node; generate a resynchronization request identifying the delayed computing node; and transmit the resynchronization request to the delayed computing node through the network communication interface, wherein a computing node receiving the resynchronization request further performs: retrieving a last locally stored federated global model representation version identifier; comparing the retrieved version identifier with a version identifier included in the resynchronization request; rolling back local model parameters to a last verified version when a mismatch is detected; and reinitializing the local training unit using the rolled back model parameters.

In this embodiment, the coordination processor enforces global training consistency through a synchronization controller that continuously tracks the participation status of every computing node in the federated network. The controller maintains a synchronization state table in non-transitory memory, where each node is associated with an expected parameter update interval derived from its historical training cadence, network latency profile, and computational capacity. During operation, the controller compares actual update reception times against the expected intervals and automatically detects when a node becomes delayed or fails to transmit an update within the permitted window. When such a condition is identified, the coordination processor generates a resynchronization request that explicitly identifies the delayed node and includes the current global model version metadata, and transmits this request to the node through the network communication interface.

Upon receiving the resynchronization request, the computing node retrieves the version identifier of the most recent federated global model representation stored in its local non-transitory memory and compares it with the version identifier contained in the request. If a mismatch is detected, indicating that the node is operating on a stale or inconsistent model, the node automatically rolls back its local parameters to the last verified model version that was previously validated and stored. The local training unit is then reinitialized using the rolled-back parameters as the starting point, ensuring alignment with the current global state before any further training or inference is performed. The technical effect achieved by this synchronization and rollback mechanism is the prevention of model drift, stale updates, and training divergence across the federated system, thereby maintaining global consistency, improving convergence reliability, and ensuring robust operation even in the presence of intermittent connectivity or node-level failures.

In an embodiment, the coordination processor further performs drift detection by: storing, in a drift monitoring buffer, historical aggregated parameter distributions; computing a divergence value between a current global parameter state matrix and a historical parameter distribution; comparing the divergence value with a predefined drift threshold; and marking the current federated global model representation as unstable when the predefined drift threshold is exceeded, wherein, upon marking the federated global model representation as unstable, the coordination processor further: selects a previous federated global model representation stored in a version archive; restores the selected previous federated global model representation to the global parameter state matrix; and reinitiates distribution using the restored federated global model representation.

In this embodiment, the coordination processor implements a model stability assurance mechanism that continuously monitors the long-term behavior of the federated global model to detect structural or statistical drift that could compromise predictive reliability. The processor maintains a drift monitoring buffer that stores historical aggregated parameter distributions corresponding to prior stable global model versions, including statistical descriptors such as mean weight values, variance profiles, and layer-wise distribution signatures. During each aggregation cycle, the current global parameter state matrix is mathematically compared with one or more historical parameter distributions by computing a divergence value using a distance metric such as Kullback- Leibler divergence, cosine distance, or Frobenius norm. This divergence value quantifies how far the current model has shifted from previously validated operating regimes.

The computed divergence value is evaluated against a predefined drift threshold that represents the maximum allowable deviation before model behavior is considered unstable. When this threshold is exceeded, the coordination processor automatically marks the current federated global model representation as unstable and blocks further distribution of the affected model. The processor then selects a previously stored and verified model version from a version archive, restores its corresponding parameter state matrix into active memory, and reinitiates the distribution process using this stable model as the new global baseline. For example, if sudden changes in data patterns from a subset of nodes cause abnormal weight shifts, the rollback mechanism prevents propagation of an unreliable model across the network. The technical effect achieved is a self-stabilizing federated learning system that can automatically detect and recover from harmful model drift, thereby preserving prediction accuracy, operational safety, and long-term reliability of the hybrid cloud control framework.

In an embodiment, controlling workload execution further comprises enforcing adaptive policy constraints by: maintaining a policy state table mapping resource usage patterns to allowable control actions; updating the policy state table based on historical control outcomes; filtering generated control action commands using the policy state table prior to transmission; and logging each filtered or permitted control action in a policy audit buffer.

In this embodiment, the workload control layer incorporates an adaptive policy enforcement mechanism that ensures all automated resource management actions remain compliant with predefined operational, security, and governance constraints while still allowing the system to evolve based on observed outcomes. A policy state table is persistently maintained in memory, where distinct resource usage patterns—such as sustained CPU saturation, memory thrashing, network congestion, or cross-environment workload imbalance—are mapped to a corresponding set of allowable control actions, including scaling limits, migration permissions, and throttling strategies. These mappings define what actions are permitted, restricted, or prohibited under specific system conditions, thereby preventing unsafe or noncompliant behavior even when the predictive model recommends aggressive control responses.

As control actions are executed and their effects are observed, the policy state table is continuously updated using historical control outcome data, such as whether a scaling event successfully reduced latency or whether a migration increased resource contention elsewhere. This feedback-driven update process enables the policy layer to adapt over time, refining which actions are most effective and which should be constrained under particular conditions. Before any generated control action command is transmitted to the cloud resource manager interface, it is evaluated and filtered against the current policy state table to ensure it complies with the allowable action set for the detected resource pattern. Every permitted or blocked action is then recorded in a policy audit buffer, creating a traceable history for compliance verification, performance tuning, and forensic analysis. The technical effect achieved by this adaptive policy enforcement architecture is a controlled, transparent, and self-optimizing workload orchestration system that balances automation with governance, reduces the risk of destabilizing actions, and enhances long-term operational reliability across the hybrid cloud environment.

In an embodiment the coordination processor further performs fault isolation by: detecting inconsistent parameter delta vectors received from a computing node relative to a cluster-level parameter distribution; temporarily suspending aggregation of the inconsistent parameter delta vectors; initiating a verification challenge to the computing node; and reinstating the computing node into the aggregation process only upon successful completion of the verification challenge.

In this embodiment, the coordination processor incorporates an automated fault isolation and trust reinforcement mechanism that protects the federated learning process from corrupted, unstable, or potentially malicious computing nodes. During each aggregation cycle, the coordination processor statistically compares incoming parameter delta vectors from each node against a cluster-level parameter distribution derived from other nodes operating under similar workload and infrastructure conditions. This comparison may involve measuring deviation magnitude, variance alignment, or distribution distance across corresponding parameter layers. When a node's delta vector exhibits an abnormal divergence pattern that falls outside an acceptable confidence band, the update is classified as inconsistent and is automatically flagged for isolation.

Upon detection of such inconsistency, the coordination processor immediately suspends aggregation of the affected parameter delta vectors, preventing them from influencing the global parameter state matrix. A verification challenge is then initiated and transmitted to the corresponding computing node, requiring the node to revalidate its training process by resubmitting integrity proofs, recomputing a reference update using a known validation dataset, or confirming its execution environment state. Only after the node successfully completes the verification challenge and its subsequent updates align with the expected cluster-level distribution is the node reinstated into the aggregation workflow. The technical effect achieved by this fault isolation mechanism is a self-protecting federated learning system that can automatically detect and contain unreliable or compromised contributors, thereby preserving global model integrity, accelerating stable convergence, and ensuring long-term robustness of the distributed hybrid cloud intelligence framework.

The plurality of computing nodes and the coordination processor are each implemented as hardware computing systems comprising at least one multi-core processor operatively coupled, through a high-speed system bus, to a non-transitory computer-readable memory storing executable instructions, parameter buffers, synchronization state tables, cryptographic key stores, and control policy tables, wherein the network communication interface of each node comprises a hardware network controller supporting secure session establishment, encrypted packet transmission, and authenticated message exchange over the hybrid cloud network. The computing nodes are further provided with local persistent storage devices configured to store operational data, training state buffers, delta caches, and versioned model representations, and with hardware-based trusted execution modules for cryptographic key protection and digital identity verification. The coordination processor is coupled to a high-throughput memory subsystem and a hardware acceleration unit configured to perform parallel parameter aggregation, hash verification, and weighted scaling operations, and is further connected to a centralized model repository and version archive stored in non-volatile storage. The deployment control unit is implemented as a dedicated hardware controller or virtualized control plane module executing on a processor, and is operatively coupled to the coordination processor and the computing nodes through the network communication interface to transmit model package containers, deployment manifests, resynchronization requests, and control action commands. A cloud resource manager interface is implemented as a hardware-backed application programming interface gateway or controller that translates control action commands into low-level resource orchestration instructions for scaling, migration, and workload placement across the private and public cloud environments.

The present disclosure relates to a system for federated artificial intelligence driven control and optimization in hybrid cloud environments, wherein computational intelligence is distributed across multiple cloud infrastructures while maintaining data locality, security, and adaptive control of resources. The system is architected to operate across private cloud environments and public cloud environments, each comprising multiple computing nodes that independently process data and collectively contribute to a global optimization objective without sharing raw data.

Each computing node includes a processor, a non-transitory computer-readable memory, and a network communication interface. Operational data generated from workloads, services, or infrastructure components within a respective cloud environment is retained locally within the memory of the computing node. A local training unit executed by the processor performs local artificial intelligence model training using only the locally retained data. The technique executed by the local training unit involves initializing a local model instance from a received global model representation, iteratively updating model parameters based on locally observed workload metrics, resource utilization patterns, latency measurements, and service performance indicators, and converging the local model parameters based on predefined local convergence criteria stored in memory. Throughout this process, the raw operational data remains confined to the originating computing node, thereby preserving data locality and regulatory compliance.

Upon completion of a local training cycle, a parameter transmission unit extracts only the locally updated model parameters and prepares them for transmission. The transmission technique includes parameter serialization, integrity tagging, and encryption prior to transfer through the network communication interface. No intermediate representations or underlying data samples are transmitted. The coordination processor, which may be logically centralized or hierarchically distributed, receives the encrypted model parameters from multiple computing nodes and performs authentication and integrity verification to ensure that the parameters originate from authorized nodes and have not been altered in transit.

The coordination processor executes an aggregation technique that combines the received local model parameters into a federated global model representation. The aggregation technique may weight individual parameter sets based on node-specific attributes such as workload volume, reliability history, or resource capacity, as determined by policies enforced by the policy control unit. The aggregation process is iterative and versioned, such that each aggregation cycle produces a uniquely identified global model representation stored with associated metadata describing contributing nodes, aggregation timing, and applied policy constraints.

The policy control unit continuously evaluates data locality rules, security constraints, and cloud-specific resource utilization policies during aggregation and deployment. Based on these evaluations, the policy control unit may dynamically exclude certain computing nodes from participation, adjust aggregation weights, or delay deployment of a global model representation. This ensures that the federated learning process adapts to changing network conditions, compute availability, and compliance requirements across the hybrid cloud environments.

Once a federated global model representation is finalized, a deployment control unit distributes the model representation back to participating computing nodes. Each computing node replaces or updates its local model instance with the deployed global model representation. The deployed model is then used in inference mode to generate control outputs that directly influence workload scheduling decisions, resource allocation parameters, scaling thresholds, and migration triggers within the local cloud environment. The inference technique maps real-time operational metrics to predicted resource demands and performance outcomes, enabling proactive control actions rather than reactive adjustments.

In secure federated configurations, computing nodes include secure memory regions that isolate sensitive operational data and model states. Local training and evaluation units operate within these secure regions, and only validated model parameters are permitted to exit the secure boundary. The federated aggregation processor authenticates each computing node prior to accepting parameter updates and continuously monitors parameter distributions across aggregation cycles. Anomalous deviations indicative of faulty behavior or compromise are detected by comparing successive aggregated representations, and nodes associated with such deviations may be excluded from future aggregation cycles.

The system further supports hierarchical aggregation in large-scale hybrid cloud deployments. In such configurations, computing nodes are grouped according to cloud infrastructure type or geographic locality, and intermediate aggregated model representations are generated prior to final global aggregation. This hierarchical technique reduces communication overhead and improves scalability while preserving the benefits of federated learning.

Through repeated cycles of local training, secure parameter exchange, federated aggregation, and controlled deployment, the disclosed system continuously optimizes workload execution and resource utilization across hybrid cloud environments. The federated artificial intelligence driven approach enables adaptive, privacy-preserving, and policy-compliant optimization while maintaining high performance and resilience in dynamic multi-cloud infrastructures.

In accordance with an embodiment, the disclosed system for federated AI-driven control and optimization in hybrid cloud environments comprises a plurality of distributed computing nodes deployed across private cloud infrastructure, public cloud infrastructure, and on-premises data centers. Each distributed computing node is equipped with a local processing unit, a memory unit, a network interface unit, and a local control unit configured to monitor operational parameters associated with compute utilization, memory consumption, storage input-output operations, network latency, packet loss, energy consumption, and workload execution characteristics.

The system further comprises a federated coordination unit operatively coupled to the distributed computing nodes through secure communication channels. The federated coordination unit is configured to orchestrate federated learning cycles by disseminating initial artificial intelligence model parameters to the distributed computing nodes and receiving locally updated model parameters generated at each node. The federated coordination unit aggregates the locally updated parameters using a weighted aggregation strategy based on node reliability, workload intensity, and data relevance, and redistributes the aggregated model parameters back to the distributed computing nodes.

Each distributed computing node executes a local learning unit configured to train the artificial intelligence model using locally observed telemetry data without transmitting the raw data outside the node. The local learning unit performs feature extraction on the monitored parameters, constructs state representations corresponding to infrastructure and workload conditions, and updates the model parameters through iterative optimization techniques. The updated model parameters represent learned control policies for resource allocation, workload placement, scaling decisions, and fault mitigation.

The system further includes a decision execution unit at each distributed computing node, wherein the decision execution unit applies the inferred control actions generated by the artificial intelligence model to dynamically adjust computing resources. Such adjustments include modifying virtual machine allocation, container placement, processor frequency scaling, memory reservation, network bandwidth throttling, and workload migration between cloud tiers. The decision execution unit operates in near real-time to respond to dynamic changes in workload demand and infrastructure state.

In an embodiment, the system includes a global policy enforcement unit configured to enforce predefined compliance, security, and service-level constraints across the hybrid cloud environment. The global policy enforcement unit validates locally inferred control actions against policy rules and ensures that optimization decisions do not violate regulatory requirements, security boundaries, or contractual service-level agreements.

The method for federated AI-driven control and optimization in hybrid cloud environments includes monitoring infrastructure and workload parameters at distributed computing nodes, performing local artificial intelligence model training using node-specific data, transmitting locally updated model parameters to a federated coordination unit, aggregating the parameters to produce a global model, redistributing the global model to the nodes, and executing control actions based on the global model inference. The method further includes continuously repeating the federated learning and optimization cycle to adapt to evolving operational conditions.

The present disclosure further provides a device for federated AI-driven control and optimization in hybrid cloud environments, wherein the device comprises a dedicated control apparatus housed within a physical enclosure adapted for deployment in a data center or network operations environment. The device includes a multi-core processing unit configured to execute federated learning techniques and optimization logic, a high-capacity memory unit for storing model parameters, telemetry data abstractions, and policy rules, and a persistent storage unit for maintaining historical performance metrics and system states.

The device further includes a plurality of network interface ports configured to establish secure communication links with distributed cloud nodes across private networks and public cloud gateways. The device incorporates a hardware security unit configured to perform cryptographic operations for secure model parameter exchange, authentication, and integrity verification. A power management unit is provided to regulate power consumption and support uninterrupted operation.

In operation, the device functions as a centralized federated coordination apparatus while allowing distributed intelligence at the cloud nodes. The device receives model updates, performs aggregation operations, validates optimization decisions against global constraints, and issues control directives to cloud infrastructure management interfaces. The physical structure of the device enables integration into existing data center racks and supports high availability configurations through redundant power and network interfaces.

The disclosed system, method, and device enable intelligent, scalable, and privacy-preserving optimization of hybrid cloud environments by distributing artificial intelligence capabilities while maintaining coordinated global control. The invention reduces latency, minimizes data transfer overhead, enhances resilience against failures, and supports compliance with data sovereignty requirements. By continuously adapting to dynamic operational conditions, the invention significantly improves resource utilization, performance stability, and operational efficiency across heterogeneous cloud infrastructures.

The invention is applicable to enterprise cloud management platforms, telecommunications networks, financial computing infrastructures, healthcare data processing environments, and large-scale industrial Internet of Things deployments requiring intelligent hybrid cloud optimization.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for federated artificial intelligence driven control and optimization in hybrid cloud environments, the method comprising;
deploying a plurality of computing nodes across at least one private cloud environment and at least one public cloud environment, each computing node comprising a processor, a non-transitory computer-readable memory, and a network communication interface;
locally storing operational data generated within each computing node in the non-transitory computer-readable memory;
executing, by the processor of each computing node, a local training unit to train a local artificial intelligence model using the locally stored operational data while preventing transfer of the operational data outside the respective computing node;
extracting locally trained model parameters from each computing node and transmitting the locally trained model parameters through the network communication interface without transmitting the underlying operational data; receiving, by a coordination processor, the locally trained model parameters from the plurality of computing nodes and verifying integrity and authenticity of the received model parameters;
aggregating, by the coordination processor, the verified locally trained model parameters to generate a federated global model representation in accordance with predefined data locality rules, security constraints, and cloud-specific resource utilization policies;
distributing, by a deployment control unit, the federated global model representation to the plurality of computing nodes;
executing the federated global model representation at each computing node to generate inference outputs based on real-time operational metrics; and
controlling workload execution, resource allocation, scaling, and migration across the hybrid cloud environments based on the generated inference outputs, wherein executing the local training unit further comprises initializing the local artificial intelligence model using a previously deployed federated global model representation, iteratively updating model parameters based on locally observed workload performance metrics, and terminating local training upon satisfying a predefined local convergence condition stored in the non-transitory computer-readable memory, and wherein transmitting the locally trained model parameters further comprises serializing the model parameters, applying cryptographic encryption, attaching integrity verification data, and transmitting the encrypted model parameters over a mutually authenticated secure communication channel.

2. The method of claim 1, wherein verifying integrity and authenticity of the received model parameters further comprises validating a digital identity associated with each computing node, checking integrity verification data, and rejecting model parameters received from unauthorized or compromised computing nodes, wherein aggregating the verified locally trained model parameters further comprises applying weighted aggregation based on at least one of workload volume, historical reliability of the computing node, network latency, or available processing capacity of the computing node, wherein aggregating the verified locally trained model parameters further comprises performing hierarchical aggregation by first aggregating model parameters within groups of computing nodes associated with a same cloud environment type, and subsequently aggregating intermediate results to generate the federated global model representation; and wherein distributing the federated global model representation further comprises assigning a version identifier to the federated global model representation, storing version metadata, and selectively deploying the federated global model representation only to computing nodes that satisfy predefined policy constraints.

3. The method of claim 1, wherein executing the federated global model representation further comprises generating predictive outputs indicative of future resource demand, workload performance, or service congestion, and wherein controlling further comprises proactively adjusting resource allocation prior to occurrence of predicted performance degradation, wherein controlling workload execution further comprises dynamically scaling processing resources, reallocating memory resources, or migrating workloads between private cloud environments and public cloud environments based on the generated inference outputs; monitoring performance indicators associated with the deployed federated global model representation at each computing node, transmitting the performance indicators to the coordination processor, and initiating a subsequent federated training cycle in response to detected deviation from predefined performance thresholds.

4. The method of claim 1, wherein executing the local training unit at each computing node further comprises: maintaining, in the non-transitory computer-readable memory, a local training state buffer storing a plurality of training state variables including a current training iteration counter, a local loss convergence value, a parameter update delta history, and a timestamp of last successful synchronization; detecting, by the processor, a training trigger event based on a change in at least one operational metric exceeding a stored threshold; loading, into an execution register, the previously deployed federated global model representation and mapping its parameter structure to a locally instantiated parameter index table; computing successive parameter updates using locally stored operational data while storing each update in a delta cache separate from the original parameter structure; and updating the training state buffer after each iteration to determine whether the predefined local convergence condition is satisfied.

5. The method of claim 4, wherein extracting the locally trained model parameters further comprises: comparing the locally updated parameter values with the parameter values of the previously deployed federated global model representation to compute a parameter delta vector; encoding the parameter delta vector using a node-specific serialization schema stored in the non-transitory computer-readable memory; segmenting the encoded parameter delta vector into transmission blocks having sequence identifiers; and storing a cryptographic hash for each transmission block in a transmission ledger prior to applying cryptographic encryption.

6. The method of claim 5, wherein transmitting the encrypted model parameters further comprises: initiating a secure session handshake with the coordination processor using a node-bound cryptographic identity; transmitting the sequence-identified transmission blocks in a predefined order; awaiting receipt acknowledgements from the coordination processor for each transmission block; and retransmitting any block for which a valid acknowledgement is not received within a stored timeout period.

7. The method of claim 1, wherein receiving and verifying the locally trained model parameters further comprises: temporarily storing each encrypted transmission block in a quarantine buffer; decrypting each transmission block using a coordination processor decryption key; reconstructing the parameter delta vector using the sequence identifiers; comparing a recalculated cryptographic hash with the corresponding stored hash received from the computing node; and moving only verified parameter delta vectors to an aggregation staging memory region.

8. The method of claim 7, wherein aggregating the verified locally trained model parameters further comprises: maintaining a node performance profile table storing historical convergence time, parameter divergence magnitude, and update reliability score for each computing node; computing a dynamic aggregation weight for each parameter delta vector using values retrieved from the node performance profile table; scaling each parameter delta vector according to the computed dynamic aggregation weight; and summing the scaled parameter delta vectors to update a global parameter state matrix, and wherein hierarchical aggregation further comprises: assigning each computing node to an environment cluster based on whether the node is deployed in the private cloud environment or the public cloud environment; aggregating scaled parameter delta vectors within each environment cluster to generate environment-level parameter matrices; normalizing the environment-level parameter matrices using stored cluster weight coefficients; and aggregating the normalized environment-level parameter matrices to update the global parameter state matrix.

9. The method of claim 1, wherein distributing the federated global model representation further comprises: embedding the updated global parameter state matrix into a model package container including a version identifier, dependency map, and deployment compatibility descriptor; generating a deployment manifest identifying eligible computing nodes based on stored policy constraints; transmitting the model package container only to computing nodes listed in the deployment manifest; and storing, at each receiving computing node, the version identifier and deployment compatibility descriptor prior to execution; wherein executing the federated global model representation further comprises: loading the received model package container into a runtime inference engine; binding real-time operational metrics to input parameter channels defined in the dependency map;
executing inference cycles at predefined time intervals; and writing inference outputs to a control decision buffer accessible to a workload orchestration module.

10. The method of claim 9, wherein controlling workload execution further comprises: retrieving inference outputs from the control decision buffer; evaluating the inference outputs against stored control rule conditions; generating at least one control action command corresponding to resource allocation, scaling, or migration; and transmitting the control action command to a cloud resource manager interface associated with the hybrid cloud environment; wherein monitoring performance indicators further comprises: collecting inference accuracy metrics, control response latency, and resource utilization metrics; storing the collected metrics in a performance log buffer; transmitting the performance log buffer to the coordination processor at predefined intervals; and comparing the transmitted performance indicators with predefined performance thresholds stored at the coordination processor; wherein initiating the subsequent federated training cycle further comprises: generating a retraining trigger signal when deviation from predefined performance thresholds is detected; broadcasting the retraining trigger signal to the plurality of computing nodes; resetting the local training state buffer at each computing node; and executing a new local training cycle using the previously deployed federated global model representation as an initialization baseline.

11. The method of claim 1, wherein the coordination processor further maintains a global synchronization controller configured to: store, in a synchronization state table, an expected update interval for each computing node; detect, based on the synchronization state table, a delayed or missing parameter update from a computing node; generate a resynchronization request identifying the delayed computing node; and transmit the resynchronization request to the delayed computing node through the network communication interface, wherein a computing node receiving the resynchronization request further performs: retrieving a last locally stored federated global model representation version identifier; comparing the retrieved version identifier with a version identifier included in the resynchronization request; rolling back local model parameters to a last verified version when a mismatch is detected; and reinitializing the local training unit using the rolled back model parameters.

12. The method of claim 1, wherein the coordination processor further performs drift detection by: storing, in a drift monitoring buffer, historical aggregated parameter distributions; computing a divergence value between a current global parameter state matrix and a historical parameter distribution; comparing the divergence value with a predefined drift threshold; and marking the current federated global model representation as unstable when the predefined drift threshold is exceeded, wherein, upon marking the federated global model representation as unstable, the coordination processor further: selects a previous federated global model representation stored in a version archive; restores the selected previous federated global model representation to the global parameter state matrix; and reinitiates distribution using the restored federated global model representation.

13. The method of claim 1, wherein controlling workload execution further comprises enforcing adaptive policy constraints by: maintaining a policy state table mapping resource usage patterns to allowable control actions; updating the policy state table based on historical control outcomes; filtering generated control action commands using the policy state table prior to transmission; and logging each filtered or permitted control action in a policy audit buffer.

14. The method of claim 1, wherein the coordination processor further performs fault isolation by: detecting inconsistent parameter delta vectors received from a computing node relative to a cluster-level parameter distribution; temporarily suspending aggregation of the inconsistent parameter delta vectors; initiating a verification challenge to the computing node; and reinstating the computing node into the aggregation process only upon successful completion of the verification challenge.
